(19) United States
(12) Patent Application Publication
(10) Pub. No.: US 2012/0276348 A1
(43) Pub. Date: Nov. 1, 2012

(54) RESILIENT FLOORING COMPOSITIONS

(76) Inventors: Robert N. Clausi, Oakville (CA); Salvatore A. Diloreto, Ancaster (CA)

(21) Appl. No.: 13/519,964

(22) PCT Filed: Jan. 7, 2011
(86) PCT No.: PCT/CA11/00025

§ 371 Date: Jun. 29, 2012

(51) Int. Cl. B32B 27/00; B32B 3/10; B32B 27/32; B32B 27/40; B32B 27/36; B32B 37/10; B32B 27/10; B32B 25/06; B32B 27/30; B32B 27/34; B32B 7/02; B32B 27/12; B32B 27/42

(52) U.S. Cl. 428/196; 428/537.5; 442/181; 428/211.1; 428/500; 428/423.1; 428/480; 428/524; 428/530; 428/511; 428/496; 428/492; 428/447; 428/474.4; 428/217; 442/239; 442/295; 428/521; 428/479.6; 428/481; 156/182

(57) ABSTRACT

Resilient flooring materials made from impregnated papers or foils and core materials are provided. As well, the methods for producing such products are provided. In particular, panels, with a layered structure, created by forming an assembly which consists of laminating a heat-activated resin impregnated decorative layer with printed graphics or a wood veneer decorative layer, a core material made up of one or more heat-activated resin-impregnated papers or other materials including linoleum, natural or synthetic rubber, cork, flexible natural fiber composites or other core materials, and a heat-activated resin impregnated paper backing layer. The heat-activated resin also acts to waterproof each of the layers and abrasion particles may be incorporated to improve wear properties. The panels may also be formed into three-dimensional products.

### FIELD OF THE INVENTION

This invention relates to multi-layer resilient flooring materials made with elastomeric thermosetting/thermoplastic resin-impregnated papers or foils and core materials. In particular, however, it relates to a resilient flexible floor coverings or high pressure laminated composite material made of layered papers and an optional flexible core material.

### BACKGROUND OF THE INVENTION

It is known that resilient floor covering materials can be made using several technologies. These technologies include rubber flooring, linoleum, cork, vinyl, etc. Vinyl flooring includes luxury vinyl tile (LVT), vinyl composition tile (VCT), and sheet vinyl flooring. Luxury vinyl tile (LVT) is a popular flooring product.

Over the last couple of decades, luxury vinyl flooring's battle for market share has largely been fought against public perception. A major negative perception about vinyl relates to the materials used to produce vinyl flooring. PVC is a major component of vinyl flooring.

Vinyl flooring is thermoplastic, which means that it can be remelted. However, there are substantial barriers to broad scale reclamation and reuse.

Vinyl flooring contains stabilizers and plasticizers. There is no standard formula for these additives and there are differences between manufacturers, so there is no uniformity to reclaimed vinyl—and therefore no easy or cost effective way of extracting these chemicals.

The same is true for limestone, the standard filler for vinyl. Limestone, which is calcium carbonate, makes up about 80% of vinyl composition tile (VCT) and VCT accounts for about 63% by volume of all commercial hard surface flooring, and its composition presents considerable barriers for reclamation.

Furthermore, there is no infrastructure for vinyl flooring reclamation. Creating such an infrastructure requires much effort and coordination, and even the most focused efforts cannot shield it from market pressures. The carpet industry has faced similar issues.

Even though PVC requires less petroleum in its formulation than other plastics, the chlorine extraction process is energy intensive. PVC is a petroleum based plastic, and that means that its production from virgin materials comes at a substantial environmental price.

Vinyl is the only plastic made largely from a non-petroleum source. The raw materials for polyvinyl chloride (PVC) are 43% petroleum and 57% salt (sodium chloride). The salt, derived from seawater, goes through electrolysis to release its chlorine, which is combined with ethylene, a petroleum derivative, to create ethylene dichloride. This chemical is converted at high temperatures to vinyl chloride, the monomer that is polymerized into polyvinyl chloride.

Vinyl is brittle by nature so for use in flooring and other applications, plasticizers and stabilizers are added. These days, stabilizers tend to be made of zinc, calcium and tin, as opposed to a couple of decades ago, when heavy metals like lead and cadmium were common. The vinyl flooring industry uses two plasticizers from the phthalate family, DINP and BBP, while in the past DEHP was used.

Another issue with vinyl is the phthalates that can leach from it. Some studies have shown that animals exposed to high levels of DEHP, a phthalate that is widely used, but no longer used in flooring, have developmental abnormalities, while other studies have not shown the same correlation. BBP, one of the phthalates used in flooring, has not been implicated. However, according to the Healthy Building Network, DINP, also widely used, has been implicated in at least one study.

Fundamental to the arguments against PVC are the toxins associated with it, particularly surrounding its chlorine content, and there is no debate about PVC's association with dioxins, a class of carcinogenic chemicals. Dioxins are released when PVC is burned, both in backyard barrel burning and in landfill fires.

LVT flooring is produced by assembling several layers including: a clear wear layer made from PVC film; a printed layer made from PVC film; a core material made from calcium carbonate and chemical plasticizers; and a backing or balancing layer made from PVC. The loose individual layers are pressed in a high pressure press, with embossing texture plates, at high temperatures. Once cured, the large sheets are die cut into tiles or planks.

Vinyl flooring is generally installed with adhesives to a smooth wood or concrete subfloor. Because of the thermoplastic nature of the vinyl, the subfloor surfaces must be smooth. Any surface imperfections such as cracks in concrete, bumps, etc. tend to telegraph or show through the floor.

Another negative perception has to do with vinyl's appearance—the glare of plastic, outdated looks, and poor representations of wood and stone.

This patent describes a new resilient flooring material that would be an alternative to vinyl made from recycled materials. The present invention aims to provide a new alternative resilient flooring material combining the natural appearance of wood, stone, tile or modern patterns and colors; containing no PVC or plasticizers; made from materials including paper, cork, wood fibers, recycled rubber sheet or natural mineral fillers; with the feel of traditional wood flooring, and being a resilient, sound reducing composition. This new product could be made in a variety of thicknesses, and installed with or without adhesive or manufactured with a self-adhesive peel and stick backing layer.

Surface texture impressions can be realized to obtain an imitation of wood grain, stone and other textures. With the known embodiments, this is performed by providing a series of impressions in the floor panels, which impressions substantially extend in the same direction or in random directions.

The significant advantages of this invention over vinyl tile would be including, but not be limited to: no PVC or harmful plasticizers; environmentally friendly water-based elastomeric resin technology; low manufacturing cost; use of post consumer or post industrial recycled materials; recyclability; good material properties including excellent UV resistance, chemical and stain resistance, high moisture stability and resistance to scratching; realistic design and feel, and durability.

### SUMMARY OF THE INVENTION

The present invention describes a resilient, flexible panel having multiple flexible layers, including floor coverings, and more particularly floor panels, whereby one or more layers comprising the resilient layer panel structure are made from papers, foils, or woven materials that may be impregnated and or coated with an elastomeric resin, film or material.

Thereby, a new resilient floor product is offered. The new invention consists of several independently treated loose flexible layers which are placed in a heated press and pressed under pressure for a period of time. The pressed panel is removed from the press and subsequently die cut or machine cut to a specific size.

The flexible layers might include (i) an optional impregnated and coated wear paper layer that has a translucent surface; (ii) an impregnated and coated decorative paper layer that has a printed surface; (iii) a core layer made from a variety of materials; (iv) a backer layer consisting of impregnated and coated paper. The above description may be modified to remove or add one or more layers depending upon the type of floor product and performance characteristics that are required.

Additional flexible layers may include one or more of the following: (i) a felt layer to add stability and reduce the possibility of telegraphing subfloor surface imperfections; (ii) a linoleum core layer; (iii) a cork core layer; (iv) a natural or synthetic rubber core layer; (v) a natural or synthetic rubber backing layer where the flooring is designed to be loose-laid without adhesive; and (vi) a pressure sensitive adhesive layer. Any of the layers may be applied in a single-step during the pressing/forming cycle or in subsequent steps after the panels have been formed from multiple layers.

The surface texture plates may also be designed for register embossing where the texture (e.g. wood plank) can correspond with the graphic image printed on the decorative layer with an embossing texture that is aligned to a graphic image.

The press may have texture plates made from chromium steel or other similar material attached to the upper and lower press platens. The surface texture plates may have various textures which correspond to the decorative paper style. An example of this would be to have wood grain texture plates combined with wood-grain printed decorative papers.

However, other materials, such as films, either based on cellulose or not, are not excluded. Moreover, each layer can be processed in different manners, for example, previous to the application thereof on the underlying basic layer, a layer may be soaked or coated in elastomeric resin or such. In addition, the elastomeric resin may consist of a solution polymer or a dispersion, or both applied in different steps to the paper or film.

Alternatively, a printed decoration can be printed directly on to the impregnated paper core layer and the decorative layer may thereby be eliminated. Further, in such a case, the elastomeric material may be impregnated onto the wear layer, or, in some cases, substituted for the wear layer. In this later case, the elastomeric material can also be modified to include wear particles for improved wear resistance, as discussed herein below. Accordingly, the entire panel assembly may be “tuned” to reduce noise depending upon the characteristics of the core panel. Each of the layers may be impregnated or receive coatings of elastomeric material. As well, the elastomeric material may also be of differing hardness.

Preferably, this elastomeric coating, film or material consists of a natural or synthetic resin with elastomeric properties, applied, for example, in very thin layers to the paper layers and/or the core. In a preferred embodiment, the papers or woven materials are saturated with the elastomeric resin, film or material.

In a second aspect, the present invention also relates to a method of production of the resilient materials, and in particular, the resilient flooring material or coverings described herein. As such, the present invention also provides a method for the production of a resilient material, and preferably a resilient flooring material, comprising preparing multiple component layers, and pressing said component layers together, wherein one or more layers comprising the resilient material are made from papers, foils or woven materials, which papers, foils or woven materials are impregnated with, or coated with, an elastomeric resin, film or material.

A further embodiment of the invention would be, to apply the impregnated decorative paper with wear particles to a linoleum, rubber or cork sheet. A loose assembly including an impregnated decorative linoleum core layer and the impregnated paper backing layer would be placed in a heated fast-cycle press to fuse the layers together into a layered resilient floor panel. Subsequent operations may include die cutting, edge machining, inspection, and packaging.

Although the invention aims at creating a new alternative resilient floor product, it will be obvious to a person skilled in the art that this inventive idea can be realized in different ways.

For resilient floor covering, and more particularly each floor panel concerned, the same elastomeric coatings may be applied to decorative papers and foils or even wood elastomeric resin impregnated wood-veneers as a core material. Further, the backing layer may have an adhesive or self-adhesive coating applied to allow for a non-glue “press and stick” product. Additionally, an elastomeric film or films may be substituted for the coating.

Of course, the invention also relates to resilient floor panels which may be produced with direct printing technology where the paper or core materials are printed directly and subsequently a translucent an impregnated elastomeric film or thermoset paper wear layer is applied to the upper surface of the panel and a pre-impregnated thermoset paper backing layer is also applied to the lower surface.

The water-based elastomeric impregnating resin (approximately 40% solids) may be applied to the thick paper-based core layer and subsequently the core panel may be placed in a vacuum chamber to allow the elastomeric dispersion resin to completely impregnate the core. Alternatively, the core paper or any of the decorative or backing papers may be subjected to a multi-step treatment using a water-based elastomeric solution that easily penetrates the papers and in a secondary step the papers may be treated with a water-based elastomeric dispersion. After the impregnation process is complete, the papers must be dried to remove all excess moisture. The papers may be processed in continuous roll form using impregnating and coating lines well known in the paper industry such as a VITS impregnation line.

The invention also relates to a method for realizing a floor panel, where the wear layer has a thermoplastic film instead of the thermoset resin-impregnated paper wear layer. This wear layer could be assembled over a decorative paper or vinyl foil or a directly printed panel, a core and a paper or thermoplastic balance layer.

Typically, the floor panels hereby are formed from larger panels.

These panels may consist of (i) a wear layer paper or foil that has been impregnated with an elastomeric thermosetting/thermoplastic resin which may include aluminum oxide or other abrasion resistant particles; (ii) a decorative layer that may be treated with a thermosetting/thermoplastic elastomeric impregnating resin; (iii) a core consisting of one or more layers of resin-impregnated paper board, linoleum, cork, natural or synthetic rubber, or flexible wood (and any combinations thereof) that may be treated with a thermosetting/thermoplastic elastomeric coating or impregnating resin; and/or (iv) a lower balancing paper or foil layer that has been impregnated with a thermosetting/thermoplastic elastomeric impregnating resin; and other possible layers.

The application of a thermosetting/thermoplastic elastomeric impregnating resin may occur during the production of any of the components of the layered assembly, or in the manufacture of any of the individual components which comprise the layered assembly. The loose assembly is transferred to a heated press to compress and fuse the layers into a whole, whereby the thermosetting/thermoplastic elastomeric impregnating resin provides for adhesion. Simultaneously during the pressing, the embossed impressions are applied, by the press, as either surface of the pressing part comes into contact with, the part to create a single layered part in accordance with the invention.

In a further embodiment, a thin elastomeric coating or film may also be applied to the upper decorative surface or the edge surfaces. The above-mentioned further embodiment will also act to seal the floor panel from moisture and provide improved wear properties.

### BRIEF DESCRIPTION OF THE DRAWINGS

With the intention of better showing the characteristics of the invention, hereafter, as an example without any limitative character, several preferred forms of embodiment are described, in the accompanying drawings, wherein:

FIG. 1 represents cross-sectional view of a typical luxury vinyl tile floor covering according to the prior art;

FIG. 2 represents an embodiment of the present invention with three impregnated paper layers;

FIG. 3 represents another embodiment of the present invention with an impregnated decorative paper layer with wear particles, multiple impregnated paper layers to build up the core layer, and an impregnated paper backer layer;

FIG. 4, represents the present invention described in FIG. 2 with a linoleum core layer;

FIG. 5, represents the present invention described in FIG. 2 with a flexible natural fiber composite core layer;

FIG. 6, represents the present invention described in FIG. 2 with a flexible cork core layer;

FIG. 7 represents the present invention described in FIG. 2 with a flexible natural or synthetic rubber core layer;

FIG. 8 represents the present invention described in FIG. 2 with a flexible expanded or solid polyethylene or polypropylene core layer;

FIG. 9 represents the present invention described in FIG. 2 with a high density flexible foam core layer;

FIG. 10 represents the present invention described in FIG. 2 with an additional felt layer below the paper core layer; and

FIG. 11. represents the present invention described in FIG. 2 with an additional impregnated glass fiber layer below the paper core layer.

### DETAILED DESCRIPTION OF PREFERRED EMBODIMENTS

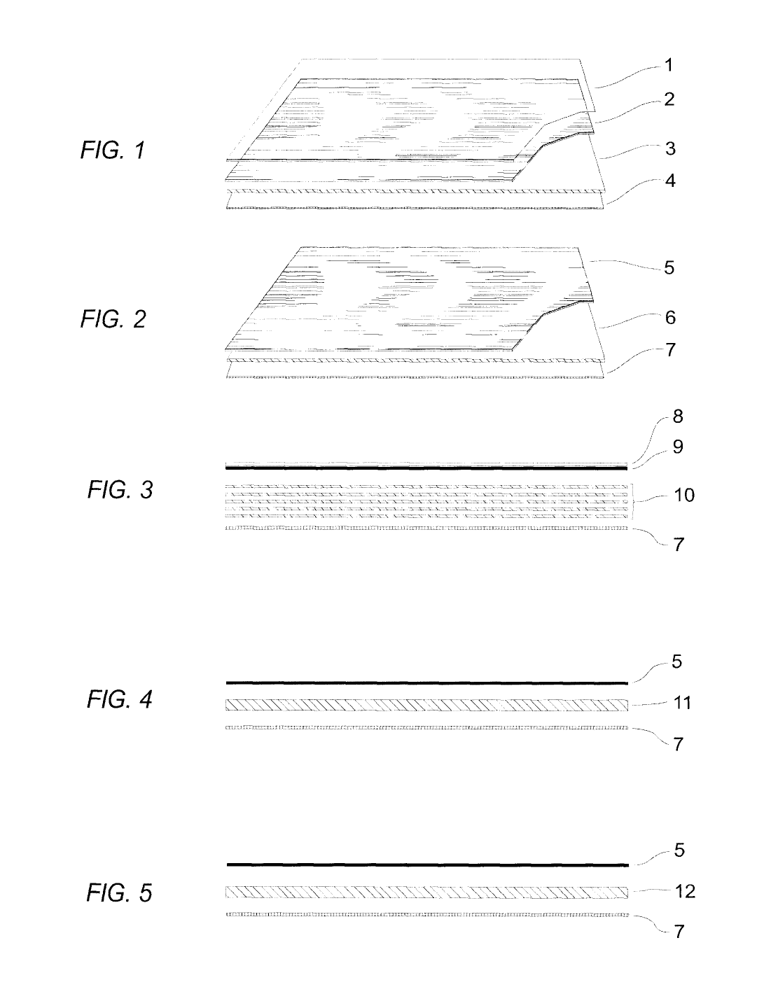

FIG. 1 is an expanded three-dimensional view of a typical luxury vinyl tile of the prior art which incorporates the clear thermoplastic PCV wear layer 1, a printed PVC decorative layer 2, a core made with calcium carbonate, plasticizers and other additives 3, and a thermoplastic PVC backer layer 4.

FIG. 2 shows an expanded three-dimensional view of a preferred embodiment of the present invention which incorporates a printed paper decorative layer impregnated with an elastomeric thermosetting/thermoplastic resin which, in an optional feature, incorporates abrasion particles 5, a paper board core layer impregnated with an elastomeric thermosetting/thermoplastic resin 6, and a paper backer layer with a weight of approximately 125 g/m² impregnated with an elastomeric thermosetting/thermoplastic resin 7.

FIG. 3 is an expanded cross section of another preferred embodiment of the present invention which includes a translucent wear layer paper with a weight of approximately 25 g/m² impregnated with an elastomeric thermosetting/thermoplastic resin which incorporates abrasion particles 8, a decorative printed paper layer with a weight of approximately 60 g/m² impregnated with flexible water based polyurethane dispersion 9, a core layer consisting of multiple core layer papers with a weight of approximately 125 g/m² impregnated with an elastomeric thermosetting/thermoplastic resin 10, and a paper backer layer with a weight of approximately 125 g/m² impregnated with an elastomeric thermosetting/thermoplastic resin 7.

FIG. 4 is an expanded cross section of another embodiment of the present invention which includes a printed decorative paper layer with a weight of approximately 60 g/m² impregnated with an elastomeric thermosetting/thermoplastic resin which incorporates abrasion particles 5, a linoleum core layer 11, and a paper backer layer impregnated with an elastomeric thermosetting/thermoplastic resin 7.

FIG. 5 is an expanded cross section of another embodiment of the present invention which includes a printed decorative paper layer with a weight of approximately 60 g/m² impregnated with an elastomeric thermosetting/thermoplastic resin which incorporates abrasion particles 5, a resilient natural fiber composite core layer 12, and a paper backer layer with a weight of approximately 125 g/m² impregnated with an elastomeric thermosetting/thermoplastic resin 7.

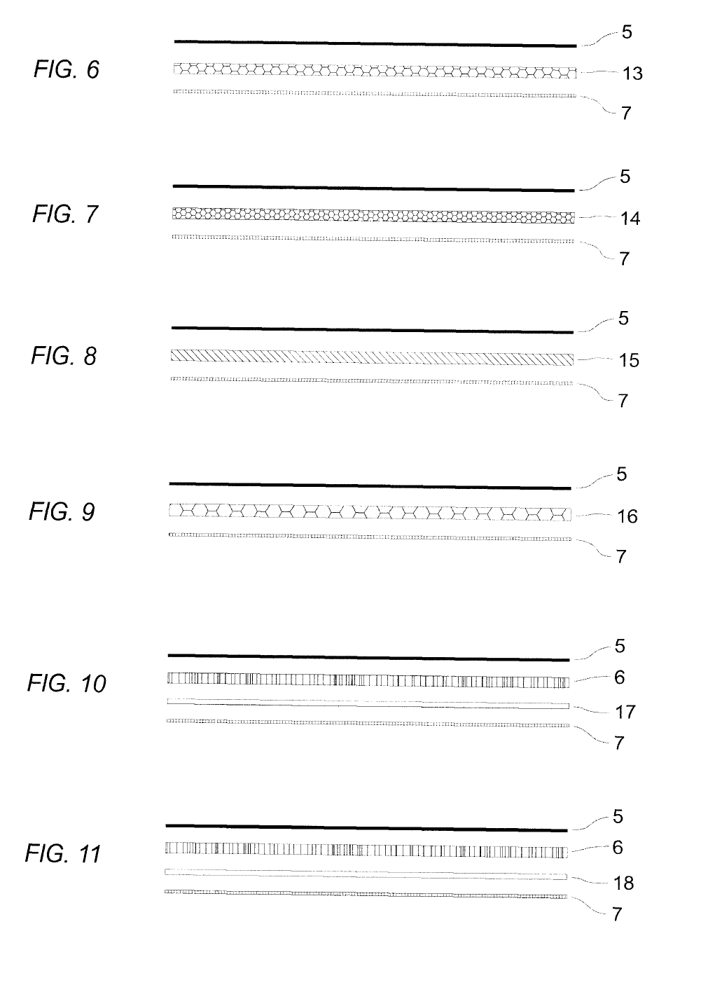

FIG. 6 is an expanded cross section of another embodiment of the present invention which includes a printed decorative paper layer with a weight of approximately 60 g/m² impregnated with an elastomeric thermosetting/thermoplastic resin which incorporates abrasion particles 5, a flexible cork core layer 13, and a paper backer layer with a weight of approximately 125 g/m² impregnated with an elastomeric thermosetting/thermoplastic resin 7.

FIG. 7 is an expanded cross section of another embodiment of the present invention which includes a printed decorative paper layer with a weight of approximately 60 g/m² impregnated with an elastomeric thermosetting/thermoplastic resin which incorporates abrasion particles 5, a flexible natural or synthetic rubber core layer 14, and a paper backer layer with a weight of approximately 125 g/m² impregnated with an elastomeric thermosetting/thermoplastic resin 7.

FIG. 8 is an expanded cross section of another embodiment of the present invention which includes a printed decorative paper layer with a weight of approximately 60 g/m² impregnated with an elastomeric thermosetting/thermoplastic resin which incorporates abrasion particles 5, a flexible expanded or solid polyethylene or polypropylene core layer core layer 15, and a paper backer layer with a weight of approximately 125 g/m² impregnated with an elastomeric thermosetting/thermoplastic resin 7.

FIG. 9 is an expanded cross section of another embodiment of the present invention which includes a printed decorative paper layer with a weight of approximately 60 g/m² impregnated with an elastomeric thermosetting/thermoplastic resin which incorporates abrasion particles 5, a flexible high density flexible foam core layer core layer 16, and a paper backer layer with a weight of approximately 125 g/m² impregnated with an elastomeric thermosetting/thermoplastic resin 7.

FIG. 10 is an expanded cross section of another embodiment of the present invention which includes a printed decorative paper layer with a weight of approximately 60 g/m² impregnated with an elastomeric thermosetting/thermoplastic resin which incorporates abrasion particles 5, a paper board core layer impregnated with an elastomeric thermosetting/thermoplastic resin 6, a felt layer 17, and a paper backer layer with a weight of approximately 125 g/m² that has been impregnated with an elastomeric thermosetting/thermoplastic resin 7.

FIG. 11 is an expanded cross section of another embodiment of the present invention which includes a printed decorative paper layer with a weight of approximately 60 g/m² impregnated with an elastomeric thermosetting/thermoplastic resin which incorporates abrasion particles 5, a paper board core layer impregnated with an elastomeric thermosetting/thermoplastic resin 6, a glass fibre layer impregnated with flexible water based polyurethane dispersion 18, and a paper backer layer with a weight of approximately 125 g/m² impregnated with an elastomeric thermosetting/thermoplastic resin 7.

Alternatively, the glass fibre layer can be replaced with a flexible cloth layer made of a natural or synthetic woven material, such as, for example, cotton, jute, polyester, or the like.

In all examples, the thermosetting/thermoplastic resin could be made from an elastomeric material in various forms including liquid, solid, film, one component or multi-component; thermoset, thermoplastic (TPE), solution polymer or water-based dispersion and latexes. Either block or alternating or random copolymers may be used. The said material can be based on, but not limited to the following polymers: PE, all grades (LLDPE, LDPE, MDPE, HDPE); Polyurethane; Polypropylene; Ethylene vinyl acetate; Ethylene vinyl alcohol; Polyester; Polyolefin (TPO); Urea and Urea-modified thermoset resins; modified Melamine-based thermoset resins; Phenolic resins; ESI—ethylene styrene interpolymer or any of the styrene acrylic copolymers and Acrylic resins; rubber based materials, NBR (nitrile Butadiene), SBR (styrene butadiene), CR (chloroprene), silicone, fluorocarbon, acrylamide, epichlorohydrin, and/or carboxylated natural and synthetic latexes. The resins may be used individually, in combinations, or as flexiblizing additives to traditional paper impregnation resins such as Melamine, Urea, and Phenolic-based resins.

The thickness of the coating is preferably from 1 micron to 3 mm, but thinner or thicker coatings might also be used. The application of the elastomeric material shall not be limited to the coating of the core or the layering papers top or bottom. The elastomeric material may comprise of a modified paper or flexible foil or a paper or foil with an elastomeric coating.

As such, the elastomeric thermosetting/thermoplastic resin could also be a flexible resin system used to coat or impregnate any or all of the paper or core layers, and/or combinations thereof. Preferably, this elastomeric material may be in the form of a water-based dispersion or a water-based solution polymer which by itself may have defined limits of elongation of 0-2000%, a 100% modulus between 0-1500 psi, and a tensile strength between 0-5000 psi by ASTM D-412.

According to a variant, the elastomeric material and the decorative layer, before their application on the base (or core) panel, may consist of a single layer, for example, in that the decorative layer is soaked such that sufficient elastomeric material is present thereupon to provide the sound absorbing and improved stress relieving properties therein. It is also not excluded to start from a layer of elastomeric material which is provided with a decorative layer at the underside, which layer is exclusively formed by a print. The term print must be interpreted in the broadest sense, and thereby any technique is intended to provide for a decorative graphic image for the panel surface.

Also, other layers may be taken up in the top layer, such as, for example, a layer of white paper, also impregnated with resin, which is provided under the decorative layer, which has the purpose of forming a neutral background.

A transparent wear layer consisting of a thermoplastic material such as PTO, polyethylene or polypropylene in various thicknesses may be added depending upon the desired performance properties. Variations in the type of material used to produce a core panel, the density of the core panel, the use of different resins or bonding agents, composites made with combinations of different resilient materials, and core panels made from other materials which may be natural-fiber based or which may be synthetic such as extruded plastics and flexible core materials, may further all benefit from the invention described herein.

Also, other materials known in the industry, such as fire retardant materials and the like, can be included within the papers, or other layers. The papers or other layers can be pretreated with these materials prior to their use in the present invention. Moreover, it will be clear that any of the resins used herein, may also include other known additives such as release agents, colouring agents, flame and smoke retardants, wear particles, and the like.

### EXAMPLES

The following examples were produced on a laboratory scale to mimic the production model to manufacture a product of the present invention. In a large-scale production, the paper layers would be impregnated using a VITS impregnation line normally used to impregnate papers for other industries such as the laminate floor industry. Once treated the papers may be stored in a roll-form awaiting pressing and die cutting operations. Pressing methods may include platen presses, continuous roll presses or calendaring-type presses.

### Example 1

Decorative papers printed with a woodgrain pattern with a weight of approximately 65 g/m² as normally used in the production of laminate flooring were cut to 20×30 cm size. A laboratory roller impregnator that consisted of a metal tray under an assembly with two rollers was used. A pre-impregnation solution bath was prepared consisting of 50% H₂O and 50% WB-90 PURchem Solution Polymer and poured into the tray. Each sheet was placed in the solution polymer and gently pulled between the rollers to remove any excess. The sheets were dried to remove excess moisture in an oven with a temperature of 90° C. for 3 minutes.

A second bath with a solution was prepared consisting of 20% H₂O and 80% WB-100 PURchem Polyurethane Water-Based Dispersion and poured into the tray. Each sheet was placed in the solution polymer and gently pulled between the rollers to remove any excess. The sheets were dried to remove excess moisture in an oven with a temperature of 90° C. for 3 minutes.

The decorative papers were coated with a solution consisting of 10% H₂O and 80% WB-110 PURchem Polyurethane Water-based Dispersion resin with Internal Mold Release (IMR)+10% of Corundum particles (Al₂O₃) with internal mold release. Each sheet was placed in the solution and gently pulled between the rollers to remove any excess. The sheets were dried to remove excess moisture in an oven with a temperature of 90° C. for 3 minutes. The dried decorative sheets were set aside. Similar steps were used to produce seven core paper sheets made from saturating kraft paper with a weight of 125 g/m². Each of the sheets had a film build of 150 g per m².

Once the sheets were pre-impregnated and subsequently dried, the loose assembly consisting of seven impregnated kraft paper sheets+the impregnated decorative sheet was placed in 100 ton heated hydraulic with upper and lower platens having a surface temperature of 150° C. The press machine was equipped with a chromium-plated steel press plate having a woodgrain texture installed on one surface designed to make impressions into the printed decorative paper. The press was closed with a surface pressure of 45 kg/m² for 60 seconds to allow the dried PURchem Polyurethane Water-Based Dispersion polymer to melt and bond the multiple sheets forming a resilient floor panel sample with a wood-grain design and corresponding surface texture.

As the end of the cycle, the sample was removed from the press, allowed to cool and cut to the desired dimensions.

### Example 2

Decorative papers printed with a woodgrain pattern with a weight of approximately 65 g/m² as normally used in the production of laminate flooring were cut to 20×30 cm size. A laboratory roller impregnator that consisted of a metal tray under an assembly with two rollers was used. A pre-impregnation solution bath was prepared consisting of 50% H₂O and 50% WB-90 PURchem Solution Polymer and poured into the tray. Each sheet was placed in the solution polymer and gently pulled between the rollers to remove any excess. The sheets were dried to remove excess moisture in an oven with a temperature of 90° C. for 3 minutes.

A second bath with a solution was prepared consisting of 20% H₂O and 80% WB-100 PURchem Polyurethane Water-Based Dispersion and poured into the tray. Each sheet was placed in the solution polymer and gently pulled between the rollers to remove any excess. The sheets were dried to remove excess moisture in an oven with a temperature of 90° C. for 3 minutes.

The decorative papers were coated with a solution consisting of 10% H₂O and 80% WB-110 PURchem Polyurethane Water-based Dispersion resin with Internal Mold Release (IMR)+10% of Corundum particles (Al₂O₃). Each sheet was placed in the solution and gently pulled between the rollers to remove any excess. The sheets were dried to remove excess moisture in an oven with a temperature of 90° C. for 3 minutes. The dried decorative sheets were set aside. Each of the sheets had a minimum film build of 150 g per m².

Once the sheets were pre-impregnated and subsequently dried, the loose assembly consisting of a 3.0 mm thick linoleum panel+the impregnated decorative sheet+an impregnated kraft paper backing sheet was placed in 100 ton heated hydraulic with upper and lower platens having a surface temperature of 150° C. The press machine was equipped with a chromium-plated steel press plate having a woodgrain texture installed on one surface designed to make impressions into the printed decorative paper. The press was closed with a surface pressure of 45 kg/m² for 60 seconds to allow the dried PURchem Polyurethane Water-Based Dispersion polymer to melt and bond the loose assembly forming a resilient floor panel sample with a wood-grain design and corresponding surface texture with a linoleum core.

As the end of the cycle, the sample was removed from the press, allowed to cool and cut to the desired dimensions.

### Example 3

Decorative papers printed with a woodgrain pattern with a weight of approximately 65 g/m² as normally used in the production of laminate flooring were cut to 20×30 cm size. A laboratory roller impregnator that consisted of a metal tray under an assembly with two rollers was used. A pre-impregnation solution bath was prepared consisting of 50% H₂O and 50% WB-90 PURchem Solution Polymer and poured into the tray. Each sheet was placed in the solution polymer and gently pulled between the rollers to remove any excess. The sheets were dried to remove excess moisture in an oven with a temperature of 90° C. for 3 minutes. A second bath with a solution was prepared consisting of 20% H₂O and 80% WB-100 PURchem Polyurethane Water-Based Dispersion and poured into the tray. Each sheet was placed in the solution polymer and gently pulled between the rollers to remove any excess. The sheets were dried to remove excess moisture in an oven with a temperature of 90° C. for 3 minutes.

The decorative papers were coated with a solution consisting of 10% H₂O and 80% WB-110 PURchem Polyurethane Water-based Dispersion resin with Internal Mold Release (IMR)+10% of Corundum particles (Al₂O₃) with internal mold release. Each sheet was placed in the solution and gently pulled between the rollers to remove any excess. The sheets were dried to remove excess moisture in an oven with a temperature of 90° C. for 3 minutes. The dried decorative sheets were set aside. Each of the sheets had a film build of 150 g per m². Once the sheets were pre-impregnated and subsequently dried, the loose assembly consisting of a 1.5 mm thick cork panel+the impregnated decorative sheet+an impregnated kraft paper backing sheet was placed in 100 ton heated hydraulic with upper and lower platens having a surface temperature of 150° C. The press machine was equipped with a chromium-plated steel press plate having a woodgrain texture installed on one surface that is designed to make impressions into the printed decorative paper. The press was closed with a surface pressure of 45 kg/m² for 60 seconds to allow the dried PURchem Polyurethane Water-Based Dispersion polymer to melt and bond the loose assembly forming a resilient floor panel sample with a wood-grain design and corresponding surface texture with a cork core. As the end of the cycle, the sample was removed from the press, allowed to cool and cut to the desired dimensions.

### Example 4

Decorative papers printed with a woodgrain pattern with a weight of approximately 65 g/m² as normally used in the production of laminate flooring were cut to 20×30 cm size. A laboratory roller impregnator that consisted of a metal tray under an assembly with two rollers was used. A pre-impregnation solution bath was prepared consisting of 50% H₂O and 50% WB-90 PURchem Solution Polymer and poured into the tray. Each sheet was placed in the solution polymer and gently pulled between the rollers to remove any excess. The sheets were dried to remove excess moisture in an oven with a temperature of 90° C. for 3 minutes.

A second bath with a solution was prepared consisting of 20% H₂O and 80% WB-100 PURchem Polyurethane Water-Based Dispersion and poured into the tray. Each sheet was placed in the solution polymer and gently pulled between the rollers to remove any excess. The sheets were dried to remove excess moisture in an oven with a temperature of 90° C. for 3 minutes.

The decorative papers were coated with a solution consisting of 10% H₂O and 80% WB-110 PURchem Polyurethane Water-based Dispersion resin with Internal Mold Release (IMR)+10% of Corundum particles (Al₂O₃) with internal mold release. Each sheet was placed in the solution and gently pulled between the rollers to remove any excess. The sheets were dried to remove excess moisture in an oven with a temperature of 90° C. for 3 minutes. The dried decorative sheets were set aside. Each of the sheets had a film build of 150 g per m².

Once the sheets were pre-impregnated and subsequently dried, the loose assembly consisting of a 6.0 mm thick cork panel+the impregnated decorative sheet+an impregnated kraft paper backing sheet was placed in 100 ton heated hydraulic with upper and lower platens having a surface temperature of 150° C. The press machine was equipped with a chromium-plated steel press plate having a woodgrain texture installed on one surface that is designed to make impressions into the printed decorative paper. The press was closed with a surface pressure of 45 kg/m² for 60 seconds to allow the dried PURchem Polyurethane Water-Based Dispersion polymer to melt and bond the loose assembly forming a resilient floor panel sample with a wood-grain design and corresponding surface texture with a cork core.

As the end of the cycle, the sample was removed from the press, allowed to cool and cut to the desired dimensions.

### Example 5

Decorative papers printed with a woodgrain pattern with a weight of approximately 65 g/m² as normally used in the production of laminate flooring were cut to 20×30 cm size. A laboratory roller impregnator that consisted of a metal tray under an assembly with two rollers was used. A pre-impregnation bath was prepared consisting of 100% WB-90 PURchem Solution Polymer and poured into the tray. Each sheet was placed in the solution polymer and gently pulled between the rollers to remove any excess. The sheets were dried to remove excess moisture in an oven with a temperature of 90° C. for 3 minutes.

A second bath was prepared consisting of 100% WB-100 PURchem Polyurethane Water-Based Dispersion and poured into the tray. Each sheet was placed in the solution polymer and gently pulled between the rollers to remove any excess. The sheets were dried to remove excess moisture in an oven with a temperature of 90° C. for 3 minutes.

The decorative papers were coated with 100% WB-110 PURchem Polyurethane Water-based Dispersion resin with Internal Mold Release (IMR)+10% of Corundum particles (Al₂O₃) with internal mold release. Each sheet was placed in the solution and gently pulled between the rollers to remove any excess. The sheets were dried to remove excess moisture in an oven with a temperature of 90° C. for 3 minutes. The dried decorative sheets were set aside. Similar steps were used to produce seven core paper sheets made from saturating kraft paper with a weight of 125 g/m². Each of the sheets had a film build of 150 g per m².

Once the sheets were pre-impregnated and subsequently dried, the loose assembly consisting of seven impregnated kraft paper sheets plus the impregnated decorative sheet was placed in 100 ton heated hydraulic with upper and lower platens having a surface temperature of 150° C. The press machine was equipped with a chromium-plated steel press plate having a woodgrain texture installed on one surface designed to make impressions into the printed decorative paper. The press was closed with a surface pressure of 45 kg/m² for 60 seconds to allow the dried PURchem Polyurethane Water-Based Dispersion polymer to melt and bond the multiple sheets forming a resilient floor panel sample with a wood-grain design and corresponding surface texture.

As the end of the cycle, the sample was removed from the press, allowed to cool and cut to the desired dimensions.

The present invention is in no way limited to the forms of embodiment described as an example and represented in the figures. On the contrary, the present invention, including floor covering, and more particularly said panels, as well as the methods described herein, may be realized in different variants without leaving the scope of the invention. The technology described herein shall not be limited to floor covering products and therefore can be used in the production of floor or wall panels, wallpapers, doorskins, furniture panels and components, automotive components, consumer goods, electronics components, foot-ware, clothing, packaging products, etc.

Thus, there has been provided, in accordance with the present invention, a resilient flooring material, and a process for producing such a flooring material, which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims. Unless otherwise specifically noted, the features described herein may be combined with any of the above aspects, in any combination.

Additionally, for clarity and unless otherwise stated, the word “comprise” and variations of the word such as “comprising” and “comprises”, when used in the description and claims of the present specification, is not intended to exclude other additives, components, integers or steps. Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively. Also, while this discussion has addressed prior art known to the inventor, it is not an admission that all art discussed is citable against the present application.

1. A resilient material, and preferably a resilient flooring material, comprising a resilient, flexible panel having multiple layers, whereby one or more layers comprising the resilient layer panel structure are made from papers, foils or woven materials, which papers, foils or woven materials are impregnated with, or coated with, an elastomeric resin, film or material.

2. A resilient flooring material as claimed in claim 1 wherein flexible panel is a floor covering.

3. A resilient flooring material as claimed in claim 2 wherein said floor covering is a floor panel.

4. A resilient flooring material as claimed in claim 1 wherein said layers of said panel comprise:
(i) an optional impregnated and coated wear paper layer that has a translucent surface;
(ii) an impregnated and coated decorative paper layer that has a printed surface;
(iii) a core layer made from a variety of materials; and/or
(iv) a backer layer consisting of impregnated and coated paper.

5. A resilient flooring material as claimed in claim 4 additionally comprising one or more of the following layers, namely:
(i) a felt layer;
(ii) a core layer of linoleum, cork, or natural or synthetic rubber;
(iii) a natural or synthetic rubber backing layer; and/or
(iv) a pressure sensitive adhesive layer.

6. A resilient flooring material as claimed in claim 1 wherein said papers, foils or woven materials are impregnated with, or coated with, an elastomeric resin, and wherein said elastomeric resin is a thermosetting or thermoplastic resin.

7. A resilient flooring material as claimed in claim 6 wherein said thermosetting or thermoplastic resin is PE, all grades (LLDPE, LDPE, MDPE, HDPE); Polyurethane; Polypropylene; Ethylene vinyl acetate; Ethylene vinyl alcohol; Polyester; Polyolefin (TPO); Urea and Urea-modified thermoset resins; modified Melamine-based thermoset resins; Phenolic resins; ESI - ethylene styrene interpolymer or any of the styrene acrylic copolymers and Acrylic resins; rubber based materials, NBR (nitrile Butadiene), SBR (styrene butadiene), CR (chloroprene), silicone, fluorocarbon, acrylamide, epichlorohydrin, and/or carboxylated natural and synthetic latexes, or combinations thereof and therebetween.

8. A resilient flooring material as claimed in claim 1 comprising two or more papers, foils or woven materials layers, wherein each of the paper, foils or woven material layers are impregnated with, or coated with, an elastomeric material.

9. A resilient flooring material as claimed in claim 8 wherein each layer of paper, foil or woven material is impregnated with, or coated with, an elastomeric material, and optionally, wherein said elastomeric materials used on each layer have differing hardness.

10. A resilient flooring material as claimed in 1 additionally comprising a transparent wear layer comprising a thermoplastic material.

11. A resilient flooring material as claimed in claim 10 wherein said wear layer is PTO, polyethylene or polypropylene.

12. A method for the production of a resilient material, and preferably a resilient flooring material, comprising preparing multiple component layers, and pressing said component layers together, wherein one or more layers comprising the resilient material are made from papers, foils or woven materials, which papers, foils or woven materials are impregnated with, or coated with, an elastomeric resin, film or material.

13. A method as claimed in claim 12 wherein said papers, foils or woven materials are saturated with said elastomeric resin, film or material.

14. A method as claimed in claim 12 wherein said elastomeric material is applied to a paper-based layer, and said resultant core panel is subsequently placed in a vacuum chamber so that said elastomeric material impregnates said layer.

15. A method as claimed in claim 12 wherein said elastomeric material is a water-based elastomeric solution that is applied to a paper-based layer, and said water-based elastomeric solution penetrates the said paper-based layer.

16. A method as claimed in claim 15 wherein said papers are processed in continuous roll form.

17. A method as claimed in claim 16 wherein said papers are processed in a VITS impregnation line.

18. A method as claimed in claim 12 wherein said resilient flooring material comprises several independently treated loose flexible layers, which layers are placed in a heated press and pressed under pressure for a period of time, removed from the press and subsequently die cut or machine cut to a specific size.

19. A method as claimed in claim 12 wherein said papers, foils or woven materials are impregnated with an elastomeric resin, and wherein said elastomeric resin is a thermosetting or thermoplastic resin.

20. A method as claimed in claim 19 wherein said thermosetting or thermoplastic resin is PE, all grades (LLDPE, LDPE, MDPE, HDPE); Polyurethane; Polypropylene; Ethylene vinyl acetate; Ethylene vinyl alcohol; Polyester; Polyolefin (TPO); Urea and Urea-modified thermoset resins; modified Melamine-based thermoset resins; Phenolic resins; ESI—ethylene styrene interpolymer or any of the styrene acrylic copolymers and Acrylic resins; rubber based materials, NBR (nitrile Butadiene), SBR (styrene butadiene), CR (chloroprene), silicone, fluorocarbon, acrylamide, epichlorohydrin, and/or carboxylated natural and synthetic latexes, or combinations thereof and therebetween.
